(19) United States
(12) Patent Application Publication
(10) Pub. No.: US 2007/0004299 A1
(43) Pub. Date: Jan. 4, 2007

(54) Barrier film with enhanced adhesive properties

(75) Inventors: John Fitch, Middletown, RI (US); Steven Sargeant, Kingston, RI (US); Gianfranco Chicarella, North Providence, RI (US); Bonnie Adams, Charlestown, RI (US)

Correspondence Address: MORRISON & FOERSTER LLP, 1650 TYSONS BOULEVARD, SUITE 300, MCLEAN, VA, 22102, US

(73) Assignee: TORAY PLASTICS (AMERICA), INC. LUMIRROR DIVISION, North Kingstown, RI (US)

(21) Appl. No.: 11/447,280

(22) Filed: Jun. 6, 2006

Related U.S. Application Data
(60) Provisional application No. 60/691,940, filed on Jun. 17, 2005.

(51) Int. Cl. B32B 5/02

(52) U.S. Cl. 442/59

(57) ABSTRACT

Described are barrier films that include a modified polyvinyl alcohol/polyvinyl amine coating resin. The barrier films exhibit a combination of good oxygen barrier properties, moisture resistance and adhesion properties characteristics.

### CROSS REFERENCE TO RELATED APPLICATION

This application claims the benefit of U.S. Provisional Application Ser. No. 60/691,940 filed Jun. 17, 2005.

### FIELD OF INVENTION

This invention relates to barrier films that include a modified polyvinyl alcohol/polyvinyl amine coating resin. The barrier films exhibit a combination of good oxygen barrier properties, moisture resistance and adhesion properties characteristics.

### BACKGROUND OF INVENTION

Barrier films are used for a variety of packaging applications such as, for example, food packaging and medical device packaging. Typically, these films are used to reduce the ingress of oxygen, moisture and occasionally carbon dioxide (CO₂) or other gases into a package. In addition, packaging films frequently act as functional barriers to prevent the egress of “organoleptics” from the inside of the package, or moisture from high moisture containing contents. An organoleptic is, for example, a material that produces a desired flavor or odor. In the case of food packaging in particular, it is desired that the packaged food retain the integrity of its taste and odor during storage. To do this, a film or film sealant layer is typically provided alone or over a cardboard or other packaging container. The sealant layer should have good organoleptic properties and should not capture the food specific taste and odor. The taste and odor of the food should not be altered, either by addition or removal, by the sealant layer. In addition, the packaging film should possess good barrier properties against oxygen and moisture or water vapor to preserve the package contents.

A variety of packaging films have been developed. U.S. Pat. No. 6,811,844 describes a multilayer packaging construction including at least one cellulosic fibrous material substrate, and at least one polymeric film coated on the cellulosic substrate, where the polymeric film is made of at least one barrier layer including an olefin polymer, and at least one sealant layer including an amorphous polyamide, the sealant layer being a layer positioned so that it may contact the packaged product.

As used herein, off line coated films are coatings that are applied to ready made film substrates. Off-line coated films are typically produced by companies that purchase film substrates directly from film manufacturers or distributors, and coat on these substrates with their own equipment any number of functional coatings. As used herein, inline coated films are coated films having coatings that are applied to the film while the film is being produced by the film manufacturer.

Examples of off-line clear barrier coated films include polyethylene terephthalate (PET) substrates or biaxially oriented polypropylene (BOPP) substrates coated with polyvinylidene chloride (PVDC). This type of coating material is a very high crystallinity, high density material that reduces gas transmission. Other common examples of off-line clear barrier coatings include metallized films such as, for example, films coated with aluminum oxide (AlOx) or silicon oxide (SiOx). Other processes include co-extrusion of polyacrylonitrile (PAN) or ethylene vinyl alcohol (EVOH) polymers or copolymers. Such materials provide good oxygen barrier protection.

Inline barrier materials can typically be produced more efficiently. However, commercially viable inline films that have both good oxygen and moisture resistance characteristics are still desired. For example, polyvinyl alcohol (PVOH) coated films are well known.

For instance, U.S. Pat. No. 5,882,747, the disclosure of which is totally incorporated by reference herein, describes a lighter than air balloon constructed from a flexible film material which has coated one or more of its interior or exterior surfaces thereon a barrier material which is not a pure metal and which has an oxygen transmission rate of less than 0.5 cm³/100 in²/24 hr. at 75° F., 65% relative humidity, said balloon being able to float when inflated with a lighter than air gas and a process for producing the balloon is provided. Additionally, U.S. Pat. No. 6,420,004 describes the formulation of polyvinyl alcohol inline coatings containing a sulfonated polyester to give excellent adhesion to the base film.

However, although these films typically possess good oxygen barrier characteristics, these films typically possess poor moisture resistance characteristics and or adhesion characteristics. In particular there is a strong need for adhesion properties.

### SUMMARY OF THE INVENTION

Described are barrier films that include a modified polyvinyl alcohol/polyvinyl amine coating resin. The barrier exhibits good moisture resistance and oxygen barrier characteristics along with exceptional adhesion properties.

One embodiment is a thermoplastic film including a thermoplastic substrate, and a barrier including a polyvinyl alcohol-polyvinyl amine and an epichlorohydrin cross-linking material disposed on a surface of the thermoplastic substrate.

Preferably, the film includes a barrier layer composition including 1 wt. % to 25 wt. %, 3 wt. % to 10 wt. %, polyvinyl alcohol-polyvinyl amine, based upon the total weight of the composition. Preferably, the film includes a barrier layer composition including 0.5 wt. % to about 10 wt. %, more preferably 1 wt. % to 5 wt. %, epichlorohydrin cross-linking material, based upon the total weight of the composition.

Preferably, the thermoplastic substrate includes a polyester, an aromatic polyester, a copolyester, a homopolyester, a polyethylene terephthalate, a glycolised polyester terephthalate, polypropylene, or a mixture thereof. Preferably, the barrier layer is applied to the substrate in a inline coating process.

Another embodiment is a process including preparing a mixture including polyvinyl alcohol-polyvinyl amine, crosslinking the polyvinyl alcohol-polyvinyl amine mixture with an epichlorohydrin cross-linking material, and disposing the cross-linked mixture upon a thermoplastic substrate. Preferably, the barrier layer is applied to the substrate in a inline coating process.

Yet another embodiment is a barrier layer including a polyvinyl alcohol-polyvinyl amine and an epichlorohydrin cross-linking material.

Another embodiment is a metallized barrier film including a substrate; a barrier layer including a polyvinyl alcohol-polyvinyl amine and an epichlorohydrin cross-linking material disposed on a surface of the substrate, and a layer comprising metal deposited onto the barrier layer.

Preferably, the layer comprising metal is vapor deposited. Preferably, the layer comprising metal includes aluminum.

### DETAILED DESCRIPTION OF THE INVENTION

PVOH is typically produced from the saponification of polyvinyl acetate and depending on the degree of saponification (i.e. the degree of hydrolysis of the PVOH), a variety of PVOH materials may be produced, ranging from partially hydrolyzed to fully hydrolyzed grades. The majority of commercially available grades of PVOH are atactic but contain significant proportions of syndiotactic diads. The high levels of crystallinity in PVOH result from the relatively small size of the hydroxyl groups, which enable it to assume both d and 1 positions in an atactic chain within a hydrogen bonded single crystal lattice.

Formula 1 below is the chemical formula for polyvinyl alcohol. As previously explained, the OH groups are highly crystallizable. The OH groups, however, are also readily cross-linked and cross-linking reduces crystallinity. The reduction in crystallinity of a PVOH containing film reduces the barrier properties of such films. However, crosslinking is an effective mechanism to increase moisture resistance and also adhesion of coatings to substrates. Therefore, there is often a compromise between barrier, adhesion and water resistance.

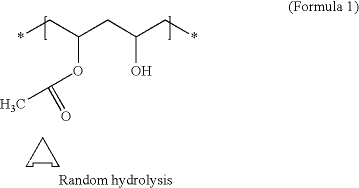

Formula 2 below is the chemical formula for polyvinyl alcohol-polyvinyl amine (PVOH/PVAM). The OH groups in PVOH/PVAM are highly crystallizable. The amine groups are also highly crystallizable. Cross-linking may not reduce the crystallinity of polyvinyl alcohol-polyvinyl amine resin when the amine component of the copolymer is preferentially reacted with an epichlorohydrin cross-linking catalyst. It is believed that the crosslinking chemistry involved may result in a type of interpenetrating network effect. Such a network is thought to maintain crystallinity of the reacted materials.

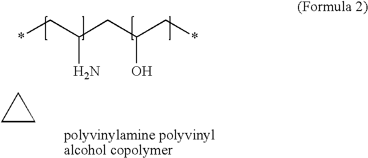

Embodiments described herein involve the barrier coatings employing a modified polyvinyl alcohol/polyvinyl amine (PVOH/PVAM) coating resin and clear barrier coated films prepared with such resins. Preferably, these coatings are clear. Preferably, these films are prepared in an inline film production process. The modified PVOH/PVAM coating resin is preferably cross-linked under conditions sufficient to produce a film having a combination of good moisture resistance and oxygen barrier characteristics and adhesion properties.

In one embodiment the method for producing the film includes disposing a modified PVOH/PVAM coating resin upon a film layer cross-linking the resin.

Due to the base sensitivity of most cross-linking resins or catalysts, most cross-linking agents possess a very poor pot life. Pot life is the length of time that a coating mixture is workable before the viscosity build up is too large to be practically processable with typical commercially equipment. It has been determined that PVOH/PVAM coating resins cross-linked with an epichlorohydrin cross-linker can posses a good pot life.

The barrier coatings can be used with either an off-line or inline coating process and provides a combination of barrier properties, water resistance, and pot life. The epichlorohydrin cross-linker of the current invention provides a combination of barrier and water resistance. In contrast, a base catalyzed cross-linking reaction does not have any appreciable pot life due to the basicity of the amine in the co-polymer barrier chemistry.

Preferably, the coating is applied in an inline process. The in line coating method may further enhance the adhesion of the coating to the substrate thereby creating a tighter bond between the substrate and the coating. This may result in improved barrier properties of the film/coating.

In an embodiment of the film, the film may include a thermoplastic substrate and a barrier layer disposed upon at least one major surface of the thermoplastic substrate. The barrier layer may include PVOH/PVAM and an epichlorohydrin cross-linking material.

Preferably, the film includes a barrier layer composition including about 1 wt. % to about 25 wt. % polyvinyl alcohol-polyvinyl amine, more preferably about 3 wt. % to about 10 wt. % polyvinyl alcohol-polyvinyl amine, based upon the total weight of the composition.

Preferably, the film includes a barrier layer composition including about 0.5 wt. % to about 10 wt. % epichlorohydrin cross-linking material, more preferably about 1 wt. % to about 5 wt. % epichlorohydrin cross-linking material based upon the total weight of the composition.

Preferably, the substrate film is a thermoplastic substrate. Preferably, the substrate includes a polyester, an aromatic polyester, a copolyester, a homopolyester, a glycolised polyester terephthalate, polypropylene, or a mixture thereof.

An embodiment of a method for preparing a barrier film includes preparing a mixture including polyvinyl alcohol-polyvinyl amine, reacting the polyvinyl alcohol-polyvinyl amine mixture with an epichlorohydrin cross-linking material, and disposing the cross-linked mixture upon a thermoplastic substrate.

A smooth coating surface devoid of defects is preferably selected to maintain a good barrier sheet. In the case of inline coating on a film line several issues may contribute to coating defects. Therefore, preferably the wetting of the barrier coating resin on the substrate film is increased. Such wetting may be increased preferably through the introduction of surfactants or co-solvents into the coating formulations, corona or flame treating the base film prior to the application of the barrier coating or any combination of these effects.

Preferably, the barrier films provide a MVTR of less than 0.75 g (100 in²/day), more preferably, less than 0.5 g (100 in²/day), even more preferably less than 0.45 g (100 in²/day).

Preferably, the O₂TR of the barrier film is less than or equal to 0.5 g/100 in2/day, more preferably less than or equal to 0.2 g/100 in2/day.

Preferably, the polyvinyl alcohol-polyvinyl amine barrier layer of the barrier film has a thickness of 0.03 μm to 0.15 μm, more preferably, 0.03 to 0.10 μm.

Table 1 provides a comparison between different grades of polyvinyl alcohol and PVOH/PVAM. Sample 1 is CELVOL 165SF a super hydrolyzed polyvinyl alcohol available from Celanese. Sample 2 is AIRVOL 305 a fully hydrolyzed polyvinyl alcohol, currently available as CELVOL 305 available from Celanese Corporation. Sample 3 is DIAFIX C631, formerly available as DIAFIX C601, a polyvinyl/amine resin commercially available from Mitsubishi Chemical Group cross-linked with the water soluble polyamide epichlorohydrin cross-linking agent POLYCUP 172, commercially available from Hercules Inc.

The samples in Table 1 were prepared by dissolving the coating materials into boiling water at about 6 wt. % solid content and filtering the residues. The remaining solution was cooled to room temperature. For samples 4-6, an aliquat of epichloryhydrin type crosslinking additive was added to the liquid at about 1.5 wt./wt. solid content. The coating solutions were then coated onto biaxially oriented PET films and dried in a forced hot air oven at about 150° C. for about 2 minutes. The reported thickness of the coating is measured via dissolution of the coating in an appropriate solvent from the dried films. For samples 4-6, the coatings were extremely aggressively bound to the PET substrates. In this case the coatings were removed either with neat acidic acid or 3N HCl. The barrier properties of the coated films were measured with standard equipment and procedures. In the case of the samples 4-6, in addition to the very aggressive binding of the coatings to the thermoplastic base sheet, the films also exhibited improved barrier properties at high humidity. Accordingly, the resulting films provided moisture resistance and improved oxygen barrier properties at both high and low humidity.

TABLE 1

| | | | | Oxygen | Oxygen | |
|---|---|---|---|---|---|---|
| | | | | Transmission | Transmission | |
| | | | | Rate | Rate | Moisture |
| | | | Thickness | (0% Relative | (90% Relative | Transmission |
| Sample # | Material | Description | (micrometers) | Humidity) | Humidity | Rate |
| 1 | Super hydrolyzed | CELVOL | 0.09 | 0.01 | — | 0.92 |
| | PVOH 99.3% | 165SF | | | | |
| 2 | Fully hydrolyzed | AIRVOL | 0.09 | 0.03 | — | 0.92 |
| | PVOH | 305 | | | | |
| | 98-98.8% | | | | | |
| 3 | polyvinyl alcohol- | DIAFIX | 0.09-.3 | .14-2.0 | — | .04-.9 |
| | polyvinyl amine | C631 | | | | |
| | copolymer | | | | | |
| 4 | polyvinyl alcohol- | | 0.05 | 0.02 | 0.05 | 0.4 |
| | polyvinyl amine | | | | | |
| | copolymer cross- | | | | | |
| | linked with | | | | | |
| | Epichlorohydrin | | | | | |
| | Type cross-linker | | | | | |
| 5 | polyvinyl alcohol- | | 0.12 | 0.02 | 0.02 | 0.4 |
| | polyvinyl amine | | | | | |
| | copolymer cross- | | | | | |
| | linked with | | | | | |
| | Epichlorohydrin | | | | | |
| | Type cross-linker | | | | | |
| 6 | polyvinyl alcohol- | | 0.14 | 0.02 | 0.02 | 0.05 |
| | polyvinyl amine | | | | | |
| | copolymer cross- | | | | | |
| | linked with | | | | | |
| | Epichlorohydrin | | | | | |
| | Type cross-linker | | | | | |

This invention will be better understood with reference to the following non-limiting examples, which are intended to illustrate specific embodiments within the overall scope of the invention.

### EXAMPLES 1-3

A polyester film was prepared for each of the Examples 1, 2, and 3, described in the Table 2, below, by dissolving 6 wt. % polyvinyl alcohol-polyvinyl amine copolymer having a 6 wt. % solids loading, into boiling water and filtering. The epichlorohydrin cross-linking agents were added to the polyvinyl alcohol-polyvinyl amine copolymer at an amount of 4 wt. % to the wt. % of the polyvinyl alcohol-polyvinyl amine copolymer. For example, for a 50 gram solution of polyvinyl alcohol-polyvinyl amine copolymer, 1.0 gram of epichlorohydrin cross-linking agent having a 12 wt. % solids loading is added to the polyvinyl alcohol-polyvinyl amine copolymer. For a 50 gram solution of polyvinyl alcohol-polyvinyl amine copolymer, 0.3 grams of epichlorohydrin cross-linking agent having a 35 wt. % solids loading is added to the polyvinyl alcohol-polyvinyl amine copolymer.

The thermoplastic base films for the following inline coated examples were generally prepared according to the following procedure. The base film was prepared from dried virgin PET pellets with an IV of 0.65 mixed with a minor amount of masterbatched PET materials with about 2 wt. % of 2.3 μm silica particles to prevent coefficient of friction (COF) issues. This mixture of materials was extruded onto a casting drum maintained at 25° C., pinned down to the drum via electrostatic force. The base film was oriented in the machine direction (MD) at about a 3.3 draw ratio. The film was then corona treated and the various test coatings were applied with a Meyer rod. The film was then heated and stretched in the transverse direction (TD) at a 3.3 draw ratio. Within the TD direction stretcher, referred to as a stenter, the coated film was exposed to 3 separate heating zones at 85° C., 100° C. and 225° C. respectively. The resultant clear films were wound for further evaluation.

In Examples 1-3, the 6% polyvinyl alcohol-polyvinyl amine copolymer was used as a control with no cross-linker added. It was coated with 3 different coat weights using # 3, 6, and 9 Meyer rods. Other application methods may be employed, such as, but not limited to, for example gravure coating, roll coating, slot die coating and air knife coating.

For Example 1, 100 grams of polyvinyl alcohol-polyvinyl amine copolymer was coated onto a polyester film after machine direction orientation (MDO) with a # 3 Meyer rod. The film/coating entered into the stenter which stretches the film in the TD. This is where the coating is dried and cross-linked as the film becomes oriented to provide a coated dry film having a film thickness of 1 gram per meter squared (gsm).

### EXAMPLES 4-6

In Examples 4-6, a 6% polyvinyl alcohol-polyvinyl amine copolymer was mixed with a water soluble polyamide epichlorohydrin cross-linker. 2 grams of a water soluble polyamide epichlorohydrin cross-linking agent having a solids loading of 12 wt. % was added to 100 grams of polyvinyl alcohol-polyvinyl amine copolymer. The water soluble polyamide epichlorohydrin cross-linking agent was added directly into the polyvinyl alcohol-polyvinyl amine copolymer while mixing. The mixture of polyvinyl alcohol-polyvinyl amine copolymer and a water soluble polyamide epichlorohydrin cross-linking agent mixture was then applied onto the polyester film with a rod coater as described with respect to Examples 1-3. These examples are summarized in Table 2 below along with the Moisture Vapor Transmission Rate for each example. For Example 4, the film had a thickness of 11 gsm.

### EXAMPLE 7-9

In Examples 7-9 a 6% polyvinyl alcohol-polyvinyl amine copolymer was mixed with a water soluble polyamide epichlorohydrin cross-linker. 7 grams of a water soluble polyamide epichlorohydrin cross-linking agent having a solids loading of 35 wt. % was added to 100 grams of polyvinyl alcohol-polyvinyl amine copolymer. The resultant solution was coated as described with respect to Example 1-3. These examples are summarized in Table 2 below along with the Moisture Vapor Transmission Rate for each example. Example 7 provided a film with a thickness of 11 gsm.

TABLE 2

| | | Solids | | |
|---|---|---|---|---|
| | | (Weight | | MVTR |
| Example # | Material | %) | Rod # | g (100\hat{ }2/day) |
| 1 | polyvinyl | 6% | 3 | .43 |
| | alcohol- | | | |
| | polyvinyl | | | |
| | amine | | | |
| | copolymer | | | |
| 2 | polyvinyl | 6% | 6 | .41 |
| | alcohol- | | | |
| | polyvinyl | | | |
| | amine | | | |
| | copolymer | | | |
| 3 | polyvinyl | 6% | 9 | .35 |
| | alcohol- | | | |
| | polyvinyl | | | |
| | amine | | | |
| | copolymer | | | |
| 4 | water soluble | 12% | 3 | .46 |
| | polyamide | | | |
| | epichlorohydrin | | | |
| | cross-linking | | | |
| | agent | | | |
| 5 | water soluble | 12% | 6 | .42 |
| | polyamide | | | |
| | epichlorohydrin | | | |
| | cross-linking | | | |
| | agent | | | |
| 6 | water soluble | 12% | 9 | .40 |
| | polyamide | | | |
| | epichlorohydrin | | | |
| | cross-linking | | | |
| | agent | | | |
| 7 | water soluble | 35% | 3 | .48 |
| | polyamide | | | |
| | epichlorohydrin | | | |
| | cross-linking | | | |
| | agent | | | |
| 8 | water soluble | 35% | 6 | .43 |
| | polyamide | | | |
| | epichlorohydrin | | | |
| | cross-linking | | | |
| | agent | | | |
| 9 | water soluble | 35% | 9 | .41 |
| | polyamide | | | |
| | epichlorohydrin | | | |
| | cross-linking | | | |
| | agent | | | |

MVTR = g(100 in²/day) Moisture Vapor Transmission Rate using a MOCON. Inc. Permatron Test equipment using test method ASTM1249.

The data in Table 2 shows the effect of coat weight and crosslinker concentration MVTR. Example 1, 2 and 3 show that the MVTR slightly decreases with increased coat weight (rod 3, 6, 9).

Examples 4, 5, 6, 7, 8 and 9 show that increasing the concentration of crosslinker to 12% and then 35% does not significantly reduce the MVTR.

Table 3 below illustrates the affect of additional cross-linkers that were tested to improve the water resistance and adhesion of the coating to the oriented polyester (OPET) and oriented polypropylene (OPP) substrates.

TABLE 3

| | | | | Examples | | |
|---|---|---|---|---|---|---|
| Material | Chemistry | 10 | 11 | 12 | 13 | 14 |
| 6% polyvinyl | vinyl alcohol-vinyl | 100 | 100 | 100 | 100 | 100 |
| alcohol- | amine | grams | grams | grams | grams | grams |
| polyvinyl amine | | | | | | |
| copolymer(hereafter | | | | | | |
| referred to as | | | | | | |
| “the | | | | | | |
| copolymer”) | | | | | | |
| 10% water | Epichlorohydrin | | 1.2 | | | |
| soluble | | | grams | | | |
| polyamide | | | | | | |
| epichlorohydrin | | | | | | |
| cross-linking | | | | | | |
| agent | | | | | | |
| 10% Bercet ™ | Glyoxal | | | 0.4 | | |
| 2183 | | | | grams | | |
| 20% | Isocyanate | | | | 1.2 | |
| Rhodacoat ™ | | | | | grams | |
| 3% Sunrez ™ | Urea based polymer | | | | | 0.4 |
| 700C | | | | | | grams |
| 10% DC Z6040 | Epoxy functional silane | | | | | |
| OPP | | | | | | |
| Tape test | | G | G | F | G | P |
| Water resistance | | P | P | P | P | P |
| OPET(PA10) | | | | | | |
| Tape test | | G | G | G | G | G |
| Water resistance | | G | E | F | P | P |

Tape test - 3M ™ magic tape was applied to the coated surface with a 4 lb. roller. After a 1 minute dwell time, the tape was pulled quickly at a 180 degree angle and visually rated as follows:
P = Poor = >50% coating removal
F = Fair = about 20% to about 50% coating removal
G = Good = about 0% to about 20% coating removal
E = Excellent = about 0% coating removal
Water resistance test-1 drop of water was placed on the coated surface and blotted off after 1 minute. The surface was visually evaluated as follows:
P = Poor = coating was dissolved
F = Fair = water drop area was swollen
G = Good = water drop area was visible
E = Excellent = water drop area was not visible, water beads

The data in Table 3 illustrates the importance of various crosslinkers and the effect they have on adhesion and water resistance on OPP and OPET substrates.

Example 10 shows the copolymer without crosslinker. The adhesion to the OPP substrate is good but the water resistance is poor. The adhesion and the water resistance are both good on the OPET substrate.

Example 11 shows the addition of the water soluble polyamide epichlorohydrin cross-linking agent to the copolymer did not adversely affect the adhesion or the water resistance on OPP but improved the water resistance on the OPET substrate.

Example 12 shows the adhesion and water resistance is adversely affected by the addition of the crosslinker on OPP substrate and the water resistance is adversely affected on the OPET substrate.

Example 13 shows that the adhesion is not affected by the crosslinker on the OPP substrate but does affect the water resistance on both OPP and OPET substrates.

Example 14 shows the adhesion and water resistance is affected on the OPP substrate and water resistance is adversely affected on the OPET substrate.

Table 4 illustrates a synergistic effect for moisture and oxygen barrier created by the combination of cross-linked polyvinyl alcohol-polyvinyl amine copolymer clear barrier coating and vapor deposited aluminum coating. Both the O₂TR and the MVTR values are lower in the metalized sample as shown.

TABLE 4

| | O₂TR | MVTR |
|---|---|---|
| | 73° F., 0% RH | 100° F., 90% RH |
| Structure | (cc/100 in²/day) | (g/100 in²/day) |
| 12 μm OPET/Vapor deposited | 0.02 | 0.07 |
| Aluminum 2.4 O.D. | | |
| 12 μm OPET polyvinyl | 0.05 | 0.47 |
| alcohol-polyvinyl | | |
| amine copolymer | | |
| with water soluble polyamide | | |
| epichlorohydrin cross-linking | | |
| agent | | |
| 12 μm OPET/polyvinyl | 0.012 | 0.003 |
| alcohol-polyvinyl | | |
| amine copolymer | | |
| with water soluble polyamide | | |
| epichlorohydrin cross-linking | | |
| agent/ | | |
| Vapor deposited Aluminum 2.4 | | |
| O.D. | | |

Metallized films, for example, metallized films whereby the metal, typically aluminum, is deposited onto a polyvinyl alcohol coated polyester terephthalate film can exhibit reduced barrier capabilities when exposed to humidity. The present disclosure provides barrier capability even when exposed to humidity conditions.

Table 5 provides a comparison with commercial barrier coatings when coated in-line after the machine direction orientation (MDO) and then dried while orienting the polyester film in the transverse direction (TDO).

TABLE 5

| | | | | Actual coat weight | |
|---|---|---|---|---|---|
| | | | Target | | O₂TR |
| Example | Coating (% solids) | Rod | Lbs/ream | Lbs/ream | g(100 in\hat{ }2/day) |
| 15 | 6% polyvinyl alcohol- | 3 | 0.07 | 0.018 | 0.1 |
| | polyvinyl amine | | | | |
| | copolymer with water | | | | |
| | soluble polyamide | | | | |
| | epichlorohydrin cross- | | | | |
| | linking agent | | | | |
| 16 | 6% polyvinyl alcohol- | 5 | 0.19 | 0.038 | 0.049 |
| | polyvinyl amine | | | | |
| | copolymer with water | | | | |
| | soluble polyamide | | | | |
| | epichlorohydrin cross- | | | | |
| | linking agent | | | | |
| Comparative | Oxybloc ™ 32% | 5 | 1 | 0.3 | 2.56 |
| Example 1 | | | | | |
| Comparative | Oxybloc ™ 32% | 3 | 0.39 | 0.18 | 2.89 |
| Example 2 | | | | | |
| Comparative | Nanobloc ™ 7% | 5 | 0.22 | 0.039 | 8.14 |
| Example 3 | | | | | |

Oxybloc ™ is an epoXy hybrid emulsion, commercially available from ICI/Glidden.
Nanobloc ™ is a nanoclay dispersed in a polyester resin emulsion, commercially available from Inmat Corp.

For Example 15, polyvinyl alcohol-polyvinyl amine copolymer was mixed with water soluble polyamide epichlorohydrin cross-linking agent 2% by weight of the polyvinyl alcohol-polyvinyl amine copolymer. The coating was applied using a #3 Meyer rod. The measured O₂TR was extremely low indicating a commercially viable product.

For Example 16, a thicker layer of polyvinyl alcohol-polyvinyl amine copolymer was applied by the same method. The O₂TR is reduced again. The O₂TR was 0.049 and would not be as commercially advantageous at that coat rate. In Comparative examples 1 and 2 and 3 heavier coating layers than that applied for Examples 15 and 16 were applied using # 5, # 3 and #5 rods respectively. Even with the heavier coat weights the O₂TR values would be too high for most commercial applications.

This application discloses several numerical ranges in the text and figures. The numerical ranges disclosed are intended to support any range or value within the disclosed numerical ranges even though a precise range limitation is not stated verbatim in the specification because this invention can be practiced throughout the disclosed numerical ranges. It is also to be understood that all numerical values and ranges set forth in this application are necessarily approximate.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

1. A thermoplastic film comprising:
a thermoplastic substrate; and
a barrier layer comprises a polyvinyl alcohol-polyvinyl amine and an epichlorohydrin cross-linking material disposed on a surface of the thermoplastic substrate.

2. The film of claim 1, comprising a barrier layer composition comprising 1 wt. % to 25 wt. % polyvinyl alcohol-polyvinyl amine, based upon the total weight of the composition.

3. The film of claim 1, comprising a barrier layer composition comprising 3 wt. % to 10 wt. % polyvinyl alcohol-polyvinyl amine, based upon the total weight of the composition.

4. The film of claim 1, comprising a barrier layer composition comprising 0.5 wt. % to about 10 wt. % epichlorohydrin cross-linking material, based upon the total weight of the composition.

5. The film of claim 1, comprising a barrier layer composition comprising 1 wt. % to 5 wt. % epichlorohydrin cross-linking material, based upon the total weight of the composition.

6. The film of claim 1, wherein the thermoplastic substrate comprises a polyester, an aromatic polyester, a copolyester, a homopolyester, a polyethylene terephthalate, a glycolised polyester terephthalate, polypropylene, or a mixture thereof.

7. The film of claim 1, wherein the barrier layer is applied to the substrate in a inline coating process.

8. The film of claim 1, further comprising a layer comprising metal on the barrier layer.

9. A process comprising:
preparing a mixture comprising polyvinyl alcohol-polyvinyl amine;
crosslinking the polyvinyl alcohol-polyvinyl amine mixture with an epichlorohydrin cross-linking material; and
disposing the cross-linked mixture upon a thermoplastic substrate.

10. The process of claim 9, comprising a barrier layer composition comprising 1 wt. % to 25 wt. % polyvinyl alcohol-polyvinyl amine, based upon the total weight of the composition.

11. The process of claim 9, comprising a barrier layer composition comprising 3 wt. % to 10 wt. % polyvinyl alcohol-polyvinyl amine, based upon the total weight of the composition.

12. The process of claim 9, comprising a barrier layer composition comprising 0.5 wt. % to 10 wt. % epichlorohydrin cross-linking material, based upon the total weight of the composition.

13. The process of claim 9, comprising a barrier layer composition comprising 1 wt. % to 5 wt. % epichlorohydrin cross-linking material, based upon the total weight of the composition.

14. The process of claim 9, wherein the thermoplastic substrate comprises a polyester, an aromatic polyester, a copolyester, a homopolyester, a polyethylene terephthalate, a glycolised polyester terephthalate, polypropylene, or a mixture thereof.

15. The process of claim 9, wherein the barrier layer is applied to the substrate in an inline coating process.

16. The process of claim 9, further comprising depositing a layer comprising metal on a layer comprising the cross-linked mixture.

17. A barrier layer comprising:
a polyvinyl alcohol-polyvinyl amine and an epichlorohydrin cross-linking material.

18. The barrier layer of claim 17, comprising 1 wt. % to 25 wt. % polyvinyl alcohol-polyvinyl amine, based upon the total weight of a composition forming the barrier layer.

19. The barrier layer of claim 17, comprising 3 wt. % to 10 wt. % polyvinyl alcohol-polyvinyl amine, based upon the total weight of a composition forming the barrier layer.

20. The barrier layer of claim 17, comprising 0.5 wt. % to about 10 wt. % epichlorohydrin cross-linking material, based upon the total weight of a composition forming the barrier layer.

21. The barrier layer of claim 17, comprising 1 wt. % to 5 wt. % epichlorohydrin cross-linking material, based upon the total weight of a composition forming the barrier layer.

22. A metallized barrier film comprising:
a substrate;
a barrier layer comprises a polyvinyl alcohol-polyvinyl amine and an epichlorohydrin cross-linking material disposed on a surface of the substrate; and
a layer comprising metal deposited onto the barrier layer.

23. The metallized film of claim 22, comprising 1 wt. % to 25 wt. % polyvinyl alcohol-polyvinyl amine, based upon the total weight of a composition forming the barrier layer.

24. The metallized film of claim 22, comprising 0.5 wt. % to about 10 wt. % epichlorohydrin cross-linking material, based upon the total weight of a composition forming the barrier layer.

25. The metallized film of claim 22, wherein the layer comprising metal is vapor deposited.

26. The metallized film of claim 22, wherein the layer comprising metal comprises aluminum.
